(19) United States
(12) Patent Application Publication
(10) Pub. No.: US 2020/0175599 A1
(43) Pub. Date: Jun. 4, 2020

(54) SYSTEM AND METHOD FOR USER-SET FEES FOR FINANCIAL SERVICES

(71) Applicant: Aspiration Partners, Inc., Marina del Rey, CA (US)

(72) Inventor: Andrei Cherny, Phoenix, AZ (US)

(73) Assignee: Aspiration Partners, Inc., Marina del Rey, CA (US)

(21) Appl. No.: 16/268,835

(22) Filed: Feb. 6, 2019

Related U.S. Application Data
(60) Provisional application No. 62/626,860, filed on Feb. 6, 2018.

(51) Int. Cl. G06Q 40/06; G06Q 30/02

(52) U.S. Cl. CPC G06Q 40/06; G06Q 30/0283

(57) ABSTRACT

A computerized system is provided that presents consumers with the means to select and negotiate a desired fee, equal to or greater than a computed minimum acceptable fee (MAF), in exchange for financial services received from a financial firm. The system determines the MAF based upon consumer investments, checking account balance, and any other factors the consumer has negotiated for a modified MAF. As such, consumers can directly influence the fee paid to a financial firm that will commensurate with the particular financial services the consumer received.

### CROSS REFERENCE TO RELATED APPLICATION

This application claims the benefit of U.S. App. No. 62/626,860, filed Feb. 6, 2018, which is incorporated by reference.

### FIELD OF THE INVENTION

The present invention relates generally to providing financial services and, more particularly, to allowing consumers to select and negotiate the fee provided in exchange for financial services received.

### BACKGROUND OF THE INVENTION

As a general matter, financial firms can provide a broad range of financial services that facilitate various wealth management, banking and lending options for consumers. Typical financial services offered by a financial firm include commercial banking services, investment banking services, and insurance services. Traditionally, these financial services are offered to consumers in exchange for a fee determined by the financial firm. Different financial firms may impose different rates for the respective services offered, and thus a prospective consumer will often take into consideration the comparative fees when deciding on a financial firm to manage their wealth, banking and lending products and services.

However, having financial firms determine such fees often negates any consideration attributed to the consumer's specific financial services needs. This can lead to a difficult and sometimes frustrating selection process for a consumer when reviewing various types of firms and comparing the quality of financial services against the corresponding fee requirements. For example, a consumer may be forced to pay a standard fee regardless of the return on the investment. Additionally, a consumer may also be forced to pay a fixed rate for other financial services in which there is minimal management by a firm, such as fees for maintaining a checking account.

Financial firms are often large institutions that determine fees for financial services through pre-existing policies and standards. As such, the consumer is often placed at a disadvantage when trying to negotiate for a fee that is tailored to a given wealth management or banking need, considering the complexity and inefficiency a financial firm would need to expend in order to structure its fee determination model on a case by case basis. Moreover, in the traditional model, the financial firm's interests are not typically aligned with the interests of the consumer. The financial firm is incentivized to maximized fees generated by the consumer's account.

It should, therefore, be appreciated that there exists a need for a system and method of providing consumers with the means to set and negotiate the fees associated with financial services that is customized to reflect the wealth management, banking and lending needs of the consumer. The present invention fulfils this need and others.

### SUMMARY OF THE INVENTION

Briefly, and in general terms, a computerized system and method provides consumers with a platform of setting and negotiating the fees required in exchange for financial services provided by a financial firm. The system computes a minimum acceptable fee (MAF) based on the investments and checking account balances of the consumer, and subsequently prompts the consumer in selecting a desired fee, equal to or greater than the MAF, which can be zero, to be paid for the provided financial services. As such, consumers can effectively tailor the fees required in managing their wealth or banking services based on their specific selections without overburdening a financial firm from manually performing a case-by-case analysis.

More specifically, in an exemplary embodiment, the system includes a database management system (DBMS) that maintains detailed data relating to the financial services selected by consumer, including investment(s) and checking account(s). The system further includes modules for performing various tasks related to setting an appropriate fee for financial services, including a minimum fee module, a negotiating module, and a client interface module, which are discussed in detail below. The system also includes a fee-monitoring module and a financial firm interface module, to aid financial firms in monitoring irregular fee modifications. The system gathers data from the financial firm, consumers, and data sources, e.g., via a digital network, e.g., internet, to aid in populating the DBMS.

In a detailed aspect of the exemplary embodiment, a minimum fee module computes a fee minimum (FM) value based on the selected investments, checking account balance, and other factors. The FM value subsequently corresponds to a minimum fee that is acceptable to the financial firm given the financial services provided. For example, The FM can be set at zero.

In another detailed aspect of the exemplary embodiment, a client interface module provides the consumer with the MAF, along with a platform to view a summary of past investment selections, invested amount, and a comparison of fees paid against the rate of return.

In other embodiments, the MAF can be set at zero. The system can provide an upper range for the acceptable fee. The consumer can select a fee within that range.

In another detailed aspect of the exemplary embodiment, a negotiating module provides the user with opportunities to decrease or increase selected fee, based on preferences set by the consumer.

In yet another detailed aspect of the exemplary embodiment, a fee-monitoring module provides a financial firm a platform to monitor changes to fees paid by users, particularly when a feature(s) of the financial services offered has been modified, or upon a poor rate of return on an investment. The financial firm is able to access this information via the financial interface module.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 is a simplified block diagram of a system in accordance with the invention.

FIG. 2 is a simplified block diagram of database management system (DBMS) of the system of FIG. 1.

FIG. 3 is a screenshot of a checking account summary provided to the consumer.

FIG. 4 is a screenshot of a financial service transaction summary between the consumer and the financial firm.

### DETAILED DESCRIPTION OF THE PREFERRED EMBODIMENTS

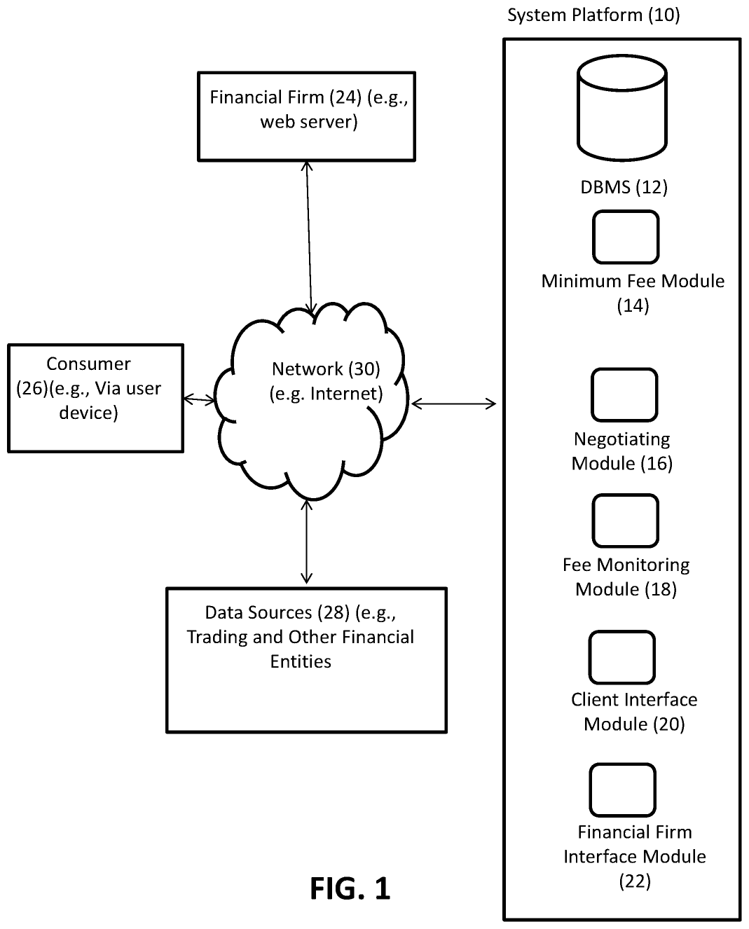

Referring now to the drawings, and particularly FIG. 1, there is shown a computerized system 10 that provides consumers 26 with a platform to select and negotiate a desired fee in exchange for financial services provided by a financial firm 24. Based on the financial services selected by a consumer 26 and the investment amount, the system platform 10 computes a minimum acceptable fee (MAF), wherein the consumer 26 can select a desired fee equal to or greater than said MAF to be paid to the financial firm 24. In the exemplary embodiment, the MAF is zero. The fees can be paid as a percentage of the investment amount or a set dollar figure. As such, consumers 26 can directly influence the amount of fees paid to a financial firm 24.

In an exemplary embodiment, the system presents a fee range 48 having a lower end 36 (MAF) and an upper end 50, (FIG. 4). The consumer can set the desired fee anywhere along that range.

With continued reference to FIG. 1, the system platform 10 connects to consumers 26, a financial firm 24, and data sources 28 via a secure digital network 30, e.g., internet. The system 10 includes a database management system (DBMS) 12 that maintains detailed data relating to the financial services provided to the consumer 26 by the financial firm 24, including investment funds and checking account balances. The financial firm 24 represents a server that contains a network and database of financial information, including its customers, investments, checking account balances, investments, and means for investing, among others. The data sources 28 can include any number of different entities that are part of the financial market and contain information regarding stocks, bonds, mutual funds, etc. The system 10 further includes modules for performing various tasks related to allowing a consumer 26 to select and modify fees, including a minimum fee module 14, a negotiating module 16, and a client interface module 20, which are discussed in detail below. The system 10 also includes a fee-monitoring module 18 and a financial firm interface module 22 to allow a financial firm 24 receive notification of the selected fees, and monitor any changes in fees set by a consumer due to policy/business model changes, or a poor rate of return on an investment.

The system platform can be implemented in a variety of applications without departing from the invention, so long as the system has the authorization to access the consumers' 26 information from the financial firm 24. In an exemplary embodiment, the system 10 can be implemented within the financial firm's server 24. As such, the system would have direct access to the consumers' 26 investments and checking account(s) with the financial firm 24, and thus provide consumers 26 a single platform to manage investments, maintain a checking account(s), and select/negotiate a desired fee for the provided financial services.

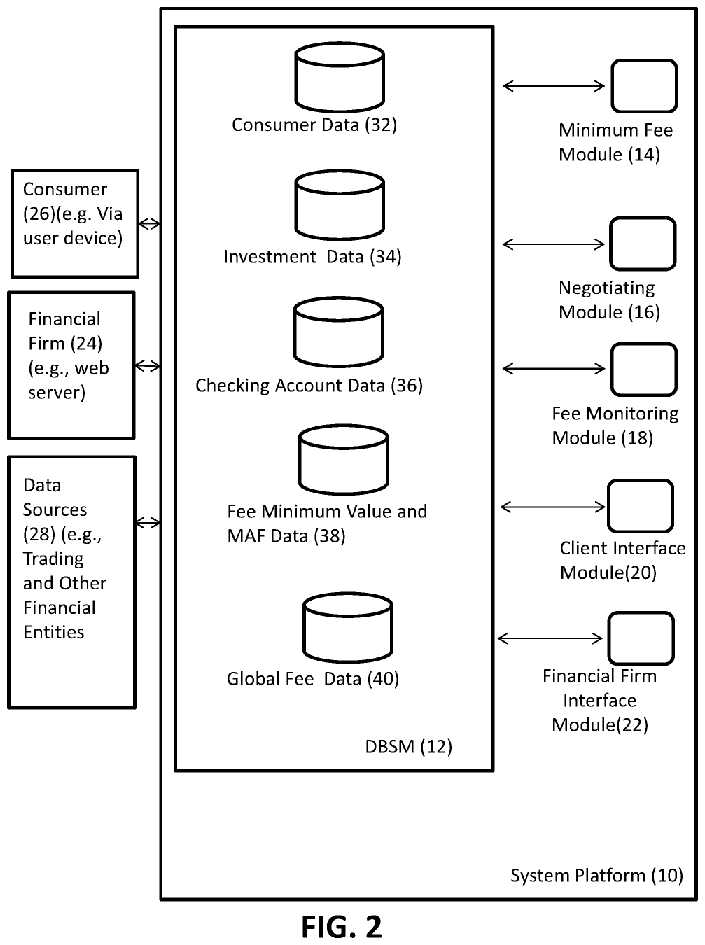

With reference now to FIG. 2, there is shown a simplified block diagram of database management system (DBMS) 12 of the system. The DBMS 12 allows the system platform 10 to have access to detailed data relating to the financial services provided by the financial firm 24, which include information regarding the consumers 32, the investment data 34, and checking accounts 36.

### Consumer Data

Consumer data 32 includes information regarding the consumer 26 such as name, address, contact information, financial history, etc. Data is primarily obtained through the financial firm server 24, but data can also be attained from the consumer via a user device.

### Investment(s) Data

Investment(s) data 34 include the investments that the consumer 26 has made using the financial firm, such as capital investments or a mutual fund. Investment data 34 typically includes the details regarding the type of investment made. For example, the mutual fund data will contain information regarding what specific investments, e.g. stocks, bonds, etc., make up the fund, the current value of the consumer's investment in the mutual fund, and mutual fund performance, among others. It can also include a trend tracking the investment performance over a given period. The system platform 10 receives investment data 34 primarily from the financial firm server, but can also receive data from other sources, e.g., consumer 26, or data sources 28 that provide financial information on traded funds.

### Checking Account Data

Checking account data 36 typically includes the details regarding the balance a consumer 26 contains in the account, and the amount of interest the account has generated for the consumer, an itemized listing of all the transactions that have taken place with the checking account, including services or goods purchased, and deposits made to the account. The system 10 receives checking account data 36 primarily from the financial firm server, but can also obtain data from consumers 26.

### Fee Minimum Value and Minimum Acceptable Fee Data

In an exemplary embodiment, the minimum fee module 14 accounts for several primary parameters in providing a MAF for financial services provided. More particularly, the minimum fee module 14 assigns a Fee Minimum (FM) value that corresponds to a specific MAF that the financial firm 24 deems acceptable for the financial services provided. The FM value is determined based on factors such as consumer's investments, checking account balance, and negotiated factors (further described below in the negotiating module). The factors are assigned a variable weighted contribution towards the FM value, where each weighted contribution can vary depending on the extent of financial services used by a consumer 26, and by the number of negotiated factors that have been applied. For example, an investment amount by a consumer 26 that is above a certain threshold will be assigned a certain value; however, the total contribution to the FM value by this investment may be lowered if a negotiated factor is applied. Once the FM value is calculated, it is stored in the fee minimum value and minimum acceptable fee data (38) where the corresponding MAF amount is determined and stored. In other embodiments, the MAF can be determined as both a percentage of the total investments by the consumer 26, and a fixed dollar value. In an exemplary embodiment, the MAF can be zero.

In a detailed aspect of the exemplary embodiment, the system 10 will also include a negotiating module 16 that will provide a platform for a consumer to negotiate fees. The negotiating module will assign a weighted factor to the type of negotiating factor selected by the consumer 26, and supply this information to the fee range module for calculation of the FM value.

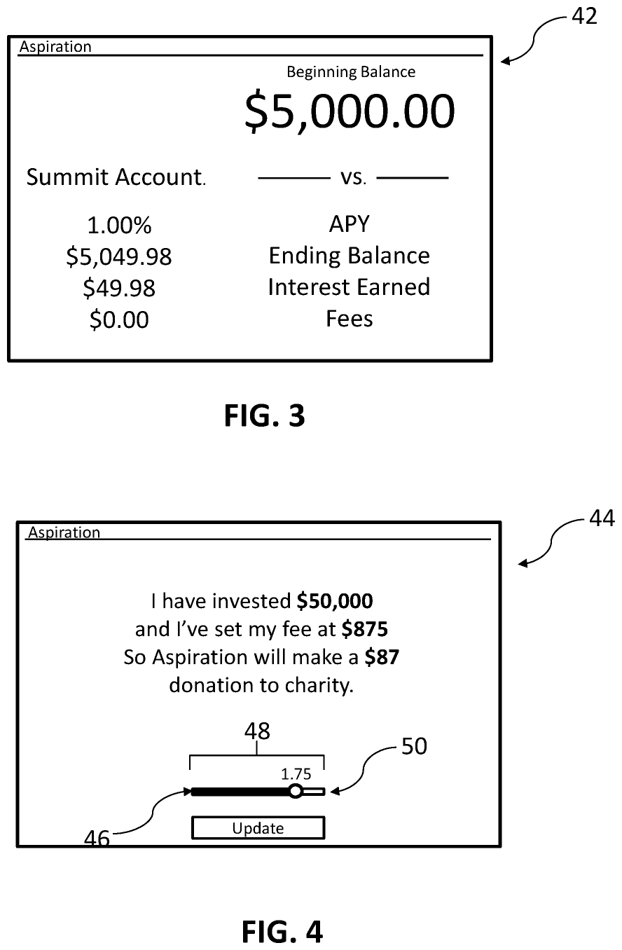

Upon determination of the MAF amount, the consumer will be prompted to select a fee equal to or greater than the MAF via the consumer interface module 20. In an exemplary embodiment, prior to selecting a desired fee, the consumer interface module can further allow a consumer to review the performance of investments by accessing the investment history from the investment data 34, which includes a net rate of return of the investments. Moreover, an accumulated interest earned from any checking accounts held by the consumer will be available, as well as the number of transactions occurred on the checking account(s), via the checking account data 36. FIG. 3 provides an exemplary screenshot 42 of a consumer interface on a user device 26, which provides a summary of an account, including starting balance, interest, earned, and bank related fees.

In yet another detailed aspect of the exemplary embodiment, the client interface module 20 will compute a donation value (DV) that will be a fraction of the selected fee by the consumer. The DV will be subsequently deducted from the selected fee, and used by the financial firm to donate to a given charity. The client interface module will further display to the consumer 26 the DV amount along with a summary of the financial relationship between the consumer and the financial firm.

FIG. 4 provides an exemplary screenshot 44 of a consumer interface on a user device 26, which displays the consumer investment amount, the selected fee, and the DV amount that will be provided by the financial firm to charity. The DV amount and selected fee will be stored with the Global Fee Data 40 in the DBMS 12. The MAF 46 would be the low end of the range 48 depicted. The upper end 50 of the range 48 can be set as well.

### Global Fee Data

Global fee data 40 includes the details regarding the fees selected by the consumer 26, along with the DV amount. The financial firm interface module 22 will communicate the selected fee (with and without the DV deduction), and the DV amount to the financial firm for processing.

The Global fee data 40 will also store fees selected by every consumer that received financial services from the financial firm, including the respective fee selection history. This can include the dates fees were set or modified.

In another exemplary embodiment, the system will include a fee-monitoring module 18 that will provide a platform for a financial firm 24 to monitor the selection and modification of fees by consumers 26 after specific events, including a policy and/or business model change by the financial firm 24, or a poor rate of return on an investment. The fee monitoring module 18 accesses the global fee data 40, and present resulting reports to the financial firm 24 based upon fee modifications by a threshold number of consumers, or irregular changes in selected fees, and align this data with any poor investment performances or other changes by the financial firm. The reports are presented via the financial firm interface module 22.

It will be appreciated that data of the DBMS 12 can be combined into different database configurations in other embodiments of this invention. Additional information regarding these databases will be discussed throughout this description. The data stored on the data storage assembly can be read, written, and executed by the various components, servers and modules included in the system.

Connections between components are shown using double-sided arrows, which may be physical, fiber optic, wireless, or any other type of communications link over a network. The network can be any of a variety of conventional network topologies and types (including optical, wired and/or wireless networks), using a variety of conventional network protocols (including public and/or proprietary protocols). The network can include, for example, home networks, cellular networks, corporate networks, Intranet(s), or the Internet, as well as possibly at least portions of one or more local area networks (LANs) and/or wide area networks (WANs) or telephone networks, among others.

The client devices that may be any of a variety of digital devices, including, for example, and not limitation, a desktop PC, a notebook or portable computer, a workstation, an Internet appliance, a handheld PC, a cellular telephone or other wireless communications device, a personal digital assistant (PDA), a set-top box, or combinations thereof. Other hardware components capable of digitally communicating and interacting with the system can be used without departing from the invention.

The system 10 can incorporate a DBMS 12 configured to store system information in digital format utilizing hardware known in the art, such as hard drive, random access memory, read only memory, flash memory, cache memory, a portable magnetic computer diskette, such as a floppy diskette, zip disk, and/or other configurations capable of storing programming, data, or other digital information on hardware devices, whether co-located or distributed across a network. The term “database management system (DBMS)” is inclusive of one or more database systems. Moreover, other hardware components capable of digitally communicating and interacting with the system can be used without departing from the invention.

The system 10 is arranged to process data, control data access and storage, issue commands, and control other desired operations, including the various modules individually and collectively (e.g., 12, 14, 16, 18, 20, and 22). The system includes a processor assembly (12, 14, 16, 18, 20, and 22) having processing circuitry configured to implement desired programming. For example, processing circuitry (hardware) may be implemented as one or more of a processor and/or other structure configured to execute executable instructions including, for example, software and/or firmware instructions, and/or hardware circuitry. Exemplary embodiments of processing circuitry include hardware logic, state machines, and/or other structures alone or in combination with a processor. Storage circuitry is configured to store programming such as executable code or instructions (e.g., software and/or firmware), electronic data, databases, or other digital information and may include processor-usable media. Processor-usable media may be embodied in any computer program, product(s), or article of manufacture(s) that can contain, store, or maintain programming, data, and/or digital information for use by or in connection with an instruction execution system including processing circuitry in the exemplary embodiment. System capabilities (including processing, data processing, data storage, module features, and others) of the system can be co-located or distributed across a network (including internet) without departing from the invention.

As will be appreciated by those of reasonable skill in the art, there are numerous embodiments to this invention, and variations of elements, steps and system components that may be used, all within the scope of this invention.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

It should be appreciated from the foregoing that the present invention provides a computerized system that presents consumers with the means to select and negotiate a desired fee, equal to or greater than a computed minimum acceptable fee (MAF), in exchange for financial services received from a financial firm. The system determines the MAF based upon consumer investments, checking account balance, and any other factors the consumer has negotiated for a modified MAF. As such, consumers can directly influence the fee paid to a financial firm that will commensurate with the particular financial services the consumer received.

The present invention has been described above in terms of presently preferred embodiments so that an understanding of the present invention can be conveyed. However, there are other embodiments not specifically described herein for which the present invention is applicable. Therefore, the present invention should not to be seen as limited to the forms shown, which is to be considered illustrative rather than restrictive.

What is claimed is:

1. A networked-based system for user-set fees for financial services, comprising:
a database management system (DBMS) that maintains consumer data, financial data, fee minimum (FM) value data, minimum acceptable fee (MAF) data, and global fee data;
a minimum fee module, in digital communication with the DBMS, that assigns a FM value that corresponds to a specific MAF, the FM value is determined based on retrieved data from the DBMS including consumer data and financial data, wherein further weighted factors are assigned to the retrieved data;
a negotiating module, in digital communication with the DBMS, that enables consumers to set fees, based on preferences by the consumer, by assigning a weighted factor to the type of negotiating factor selected by the consumer;
a client interface module, in digital communication with the DBMS, that compute a donation value (DV) that will be a fraction of the selected fee by the consumer, the DV is deducted from the selected fee, the client interface module displays to the consumer the DV amount; and
a fee-monitoring module, in digital communication with the DBMS, provides a platform for a financial firm to monitor selection and modification of fees by consumers after a defined event.

2. The system of claim 1, wherein the defined event includes a policy and/or business model change by the financial firm, or a poor rate of return on an investment.

3. The system of claim 1, wherein global fee data includes fees selected by every consumer that received financial services from the financial firm.

4. The system of claim 1, wherein the fee-monitoring module accesses the global fee data from the DBMS based upon fee modifications by a threshold number of consumers, or irregular changes in selected fees, resulting in reports presented via a financial firm interface module.
